(19) United States
(12) Patent Application Publication
(10) Pub. No.: US 2024/0286635 A1
(43) Pub. Date: Aug. 29, 2024

(54) SYSTEMS AND TECHNIQUES FOR CLASSIFICATION OF SIGNS AND GESTURES OF TRAFFIC CONTROLLERS

(71) Applicant: GM Cruise Holdings LLC, San Francisco, CA (US)

(72) Inventors: Ankit Raj, Santa Clara, CA (US); Raghid Mardini, Oakland, CA (US); Nicholas Famiglietti, Torrance, CA (US); Eric Lujan, San Francisco, CA (US); Nestor Grace, San Francisco, CA (US); Sachithra Hemachandra, Sunnyvale, CA (US); Weichao Kong, Sunnyvale, CA (US); James Hammond, San Francisco, CA (US); Changkai Zhou, Mountain View, CA (US)

(21) Appl. No.: 18/175,972

(22) Filed: Feb. 28, 2023

(51) Int. Cl. B60W 60/00

(52) U.S. Cl. CPC B60W 60/001; B60W 2554/4029; B60W 2554/404

(57) ABSTRACT

The present disclosure generally relates systems and techniques for classification of signs and gestures pertaining to traffic and, more specifically, to autonomous vehicle based classification of signs and gestures of humans controlling traffic (HCTs). In some aspects, the present disclosure provides a process for identifying, using one or more sensors of an autonomous vehicle (AV), a human controlling traffic (HCT) and recognizing a set of instructions from the HCT, wherein the set of instructions comprises a set of sensory data. In some aspects, the process can further include operations for modifying a trajectory of the AV based on the set of instructions received from the HCT and based on a determination on whether the set of instructions are intended for the AV.

### BACKGROUND

### 1. Technical Field

The present disclosure generally relates to systems and techniques for classification of signs and gestures pertaining to traffic and, more specifically, to autonomous vehicle based classification of signs and gestures of humans controlling traffic (HCT).

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions that are conventionally performed by human drivers, such as performing navigation and routing tasks necessary to provide safe and efficient transportation. Such tasks may require the collection and processing of large quantities of data using various sensor types, including but not limited to cameras, Light Detection and Ranging (LiDAR) sensors, and/or Radio Detection and Ranging (RADAR) disposed on the AV. In some instances, the collected data can be used to perform additional AV testing and training.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system for autonomous vehicle (AV) based classification of signs and gestures of humans controlling traffic, according to some examples of the present disclosure;

FIG. 2 illustrates another example system for AV based classification of signs and gestures of humans controlling traffic, according to some examples of the present disclosure;

FIG. 3 illustrates an example of a process for AV based classification of signs and gestures of humans controlling traffic, according to some examples of the present disclosure;

FIG. 4 illustrates another example of a process for implementing AV remote initialization and location sharing, according to some examples of the present disclosure;

FIG. 5 illustrates an example system environment that can be used to facilitate AV dispatch and operations, according to some aspects of the disclosed technology;

FIG. 6 illustrates an example of a deep learning neural network that can be configured to classify signs and gestures and detect a human controlling traffic, according to some aspects of the disclosed technology; and

FIG. 7 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Autonomous vehicles (AVs), also known as self-driving cars, driverless vehicles, and robotic vehicles, are vehicles that use sensors to sense the environment and move without human input. Automation technology enables the AVs to drive on roadways and to perceive the surrounding environment accurately and quickly, including obstacles, signs, and traffic lights. In some cases, AVs can be used to pick up passengers and drive the passengers to selected destinations.

As discussed above, autonomous vehicles are designed to navigate autonomously in an environment without human input or intervention. In order to successfully navigate an environment autonomously, an AV may need to understand how to plan a trajectory or path through atypical or special driving situations including, but not limited to, a construction zone, traffic intersection with one or more malfunctioning traffic lights, potholes, street closures, or any other driving situation which may require a human controlling traffic (HCT) that can direct vehicles through the special driving situation. In this example, the HCT may use at least one of hand gestures, signs (e.g., a hand-held or ground posted sign instructing the AV to slowdown, stop, navigate in a particular direction, proceed through a stop sign or red light, take a detour, etc.) or a combination thereof to instruct the AV through the special driving situation. For example, in a construction zone the HCT may instruct the AV to navigate around the construction zone through a temporary driving pathway for vehicular traffic. In other words, the path or roadway that the AV would normally navigate through (e.g., if there was not a construction zone located over the roadway) may be blocked and the HCT may instruct the AV (e.g., via a sign and/or hand gestures) to navigate through an alternate pathway (e.g., a temporary lane which may be constructed via cones or other structures to indicate the boundaries of the alternate pathway, or directing traffic to an alternate street that may be in a different direction). In another example, there may be a traffic intersection with one or more malfunctioning traffic lights that require an HCT such as a law enforcement officer to instruct vehicles through the intersection. In another example, there may be an accident scene, temporary road closure or parade that requires an HCT to instruct vehicles. In order to navigate this example autonomously, the AV may need to detect the presence of the HCT and make a determination if the HCT is communicating with the AV (e.g., rather than communicating with other vehicles). In addition, the AV may need to understand the communication of the HCT such as hand gestures, facial expressions (e.g., body orientation, gaze), and signs (e.g., the AV may need to interpret the visual or text data on the sign) to navigate through the intersection. In some instances, such as a street closure, the HCT may instruct the AV to navigate through a road, lane or street that the AV in normal circumstances would not autonomously navigate through (e.g., the HCT may instruct the AV to navigate through a street intended for traffic going the opposite direction of the AV, navigate through a red light or stop sign, etc.).

Aspects of the disclosed invention provide solutions for autonomous vehicles for classifying signs and gestures (e.g., hand and body gestures, facial expressions) of humans controlling traffic. For example, as discussed above, an AV may need to detect and interpret (e.g., using machine learning algorithms) communication signals such as hand gestures and signs from an HCT in order to navigate through or around a special driving situation (e.g., construction zone, traffic intersection, building construction, pothole repair, emergency scene, school zone, etc.). Those skilled in the art will appreciate additional examples of special driving situations. In addition, the AV may need to determine whether or not the HCT is communicating with another vehicle on the road or with the AV. In other words, the AV may need to determine whether the HCT is actively trying to communicate with traffic (e.g., the HCT may not be actively communicating with traffic and instead be communicating with another construction worker, walking around a construction site, or has their sign faced down or away from traffic). The AV may also need to determine whether or not the HCT is authorized or has the authority level to direct traffic. For example, there may be a pedestrian or driver in another vehicle using hand gestures directed towards the AV communicating instructions that the AV should not adhere to (e.g., the AV should not change its trajectory based on instructions from an unauthorized HCT). In other words, the AV may use machine learning algorithms to determine whether or not the HCT has the authority level to impact the behavior of the AV. In some examples, an HCT, such as a construction worker, law enforcement officer, emergency services worker, school crossing guard, event coordinator, and private security worker (e.g., around stadiums and events), may be considered an authorized HCT. Those skilled in the art will appreciate additional examples of HCTs with an appropriate authority level to instruct an AV). Once a determination is made by the AV that the HCT has the authority to communicate navigation instructions to the AV, the AV may then plan a response. Based on the communication of the HCT to the AV, the AV may amend its navigation through the special driving situation.

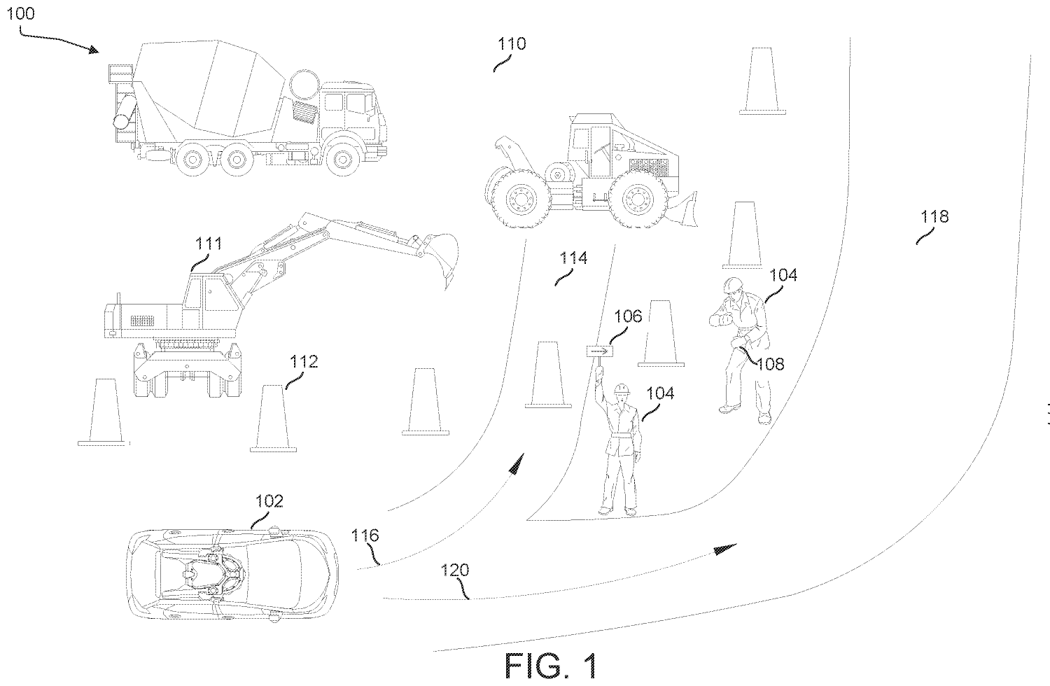

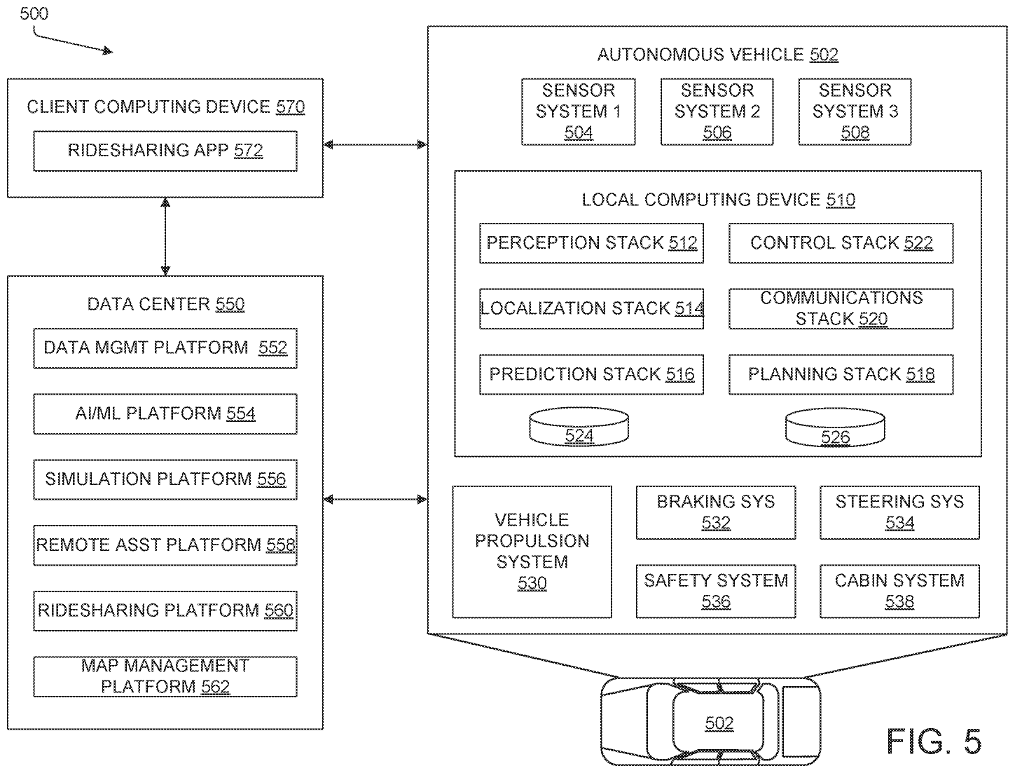

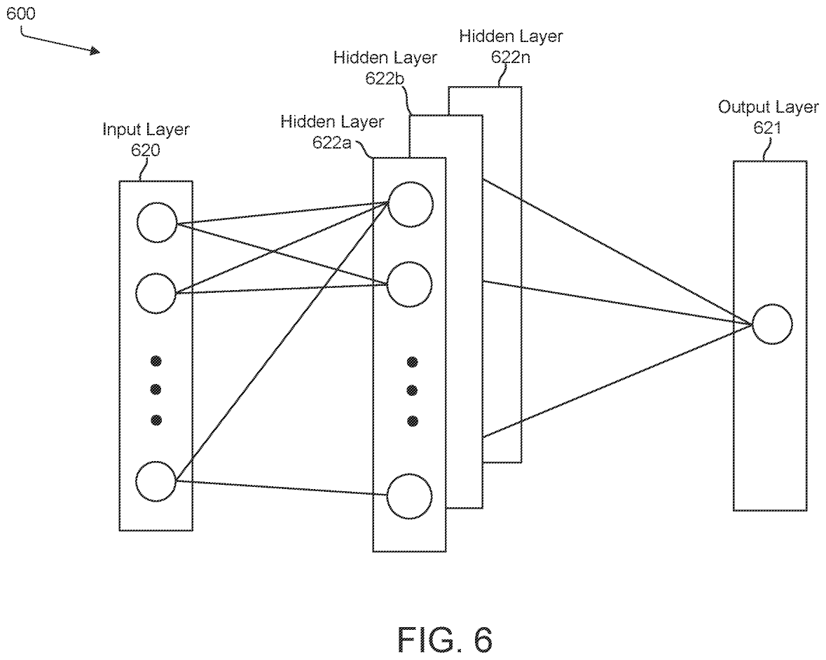

FIG. 1 illustrates an example of a scenario 100 in which an autonomous vehicle based classification of signs and gestures process may be implemented. Scenario 100 includes an AV 102, one or more humans controlling traffic (HCTs) 104, sign (also hand-held sign, ground sign, signpost, traffic sign, pole-based signs) 106, gestures (also hand gestures, body gestures, face gestures, hand signals, eye contact, non-verbal body cues, non-verbal body signals) 108, construction zone 110, one or more construction vehicles 111, one or more cones 112, normal route 114, normal trajectory 116, alternate route 118, and alternate trajectory 120. As illustrated in FIG. 1, a construction zone 110 is indicated by one or more cones 112 that indicate the geographic region in which the construction zone 110 falls within. The construction zone 110 may include one or more construction vehicles 111 performing roadwork, building construction, or any other type of construction preventing a vehicle from accessing normal route 114. In other words, under normal circumstances without construction zone 110, normal route 114 may be accessible as a roadway or path for vehicles to drive or navigate on. In some cases, AV 102 may “see” (e.g., via perception stack 512 as illustrated in FIG. 5) cones 112 and determine that the normal route 114 is inaccessible. For example, the AV 102 may determine that the normal route 114 is inaccessible via a local computing device (e.g., local computing device 510 as illustrated in FIG. 5) which may utilize a variety of approaches including, but not limited to, machine learning algorithms (e.g., via deep learning neural network 600 as illustrated in FIG. 6), deep learning, graph search, nearest-neighbors clustering, or a combination thereof. In addition, AV 102 may determine the presence of an alternate route 118 which may also be indicated via the presence of cones (not illustrated) or other structures that indicate the geographic region of alternate route 118. In some examples, alternate route 118 may be a different street than normal route 114 or a different path on the same street at normal route 114. In some examples, AV 102 may not be able to make a determination on where to navigate due to the temporary closure of normal route 114 due to construction zone 110 without any external communication. In other words, there may be a need for external communication such as communication from a human controlling traffic (HCT) 104 to instruct AV 102 on where to navigate as an alternative to the inaccessible normal route 114. In some cases, HCT 104 may provide communications to AV 102 that takes priority over other actors and may help or override with different instructions than those implicit from objects and infrastructure in the roadway or path of AV 102. In some instances, HCT 104 may use a sign 106 (e.g., hold a physical sign or gesture to a sign on the ground) to communicate instructions to AV 102 on how to navigate. For example, AV 102 may use machine learning algorithms (e.g., via deep learning neural network 600 as illustrated in FIG. 6) to detect the presence of HCT 104 and interpret sign 106 (e.g., determine the data that is communicated by sign 106). In some examples, sign 106 may include sensory data, including both visual data, written data, or a combination thereof. In some instances, AV 102 may use data from a LiDAR point cloud (e.g., LiDAR 3D point cloud) or camera to estimate the pose of HCT 104 and interpret the communication of HCT 104. In some aspects, HCT 104 may use gestures 108 to communicate instructions to AV 102 on how to navigate. For example, HCT 104 may use hand or arm gestures 108 to communicate with AV 102 to stop, slow down, speed up, navigate in a particular direction, etc. In some instances, HCT 104 may use facial movements, eye movements, gaze, body movements, or head movements (e.g., rotating the head in the direction that AV 102 is supposed to navigate) to communicate with AV 102. Some examples of gestures may include but are not limited to a straight arm for a left turn, a 90-degree upward angle arm for a right turn, a flat palm to stop, a flat palm with finger movements to slowdown, and fingers pointing to a desired location for AV 102 to navigate to. Those skilled in the art will appreciate additional examples of gestures 108 that HCT 104 may utilize to communicate with AV 102. In some cases, AV 102 may respond to the communication (e.g., via gestures 108 or sign 106) by modifying current trajectory 116 (e.g., which AV 102 would normally use for normal route 114 if there was no presence of construction zone 110) to alternate trajectory 120 to navigate through alternate route 118.

In some examples, there may be multiple vehicles (not illustrated) in the geographic area shown in FIG. 1 that also receive navigation instructions from HCT 104. The AV 102 may determine whether or not HCT 104 is communicating with AV 102 or other vehicles based on the AV's 102 current location and also on its intended future trajectory (e.g., does AV 102 intend to traverse the area of the roadway it appears the HCT 104 is intending to apply their directive to). In some instances, AV 102 may determine whether or not HCT 104 is communicating with AV 102 based on gaze or eye contact (e.g., the eyes of HCT 104 are directed towards AV 102). In another example, HCT 104 may walk towards AV 102 and as a result AV 102 may determine (e.g., using machine learning algorithms) that HCT 104 is communicating with AV 102.

In some instances, AV 102 may also make a determination (e.g., via machine learning algorithms) whether or not HCT 104 is active or inactive with respect to directing traffic in their capacity as an HCT. For example, AV 102 may perceive (e.g., via perception stack 512 as illustrated in FIG. 5) the presence of HCT 104 and interpret the information conveyed by sign 106 (e.g., via machine learning algorithms as executed via a deep learning neural network 600 as illustrated in FIG. 6) but only respond to the information if HCT 104 is active. In some cases, HCT 104 may be active if sign 106 is currently held upwards or inactive if sign 106 is not held up (e.g., placed on the ground or held facing down or backwards). In another example, HCT 104 may be active or inactive based on spatial data such as the distance between HCT 104 and AV 102 (e.g., HCT 104 may be inactive if the distance from AV 102 is above a pre-determined threshold and active below the pre-determined threshold) or the location of HCT 104 (e.g., HCT 104 may be inactive if located on the opposite side of a road or facing the direction for vehicles driving in a different direction than AV 102). Those skilled in the art will appreciate additional examples of communication scenarios with an HCT 104 and a vehicle (e.g., a non-autonomous vehicle or autonomous vehicle such as AV 102) and when HCT 104 may be inactive or active.

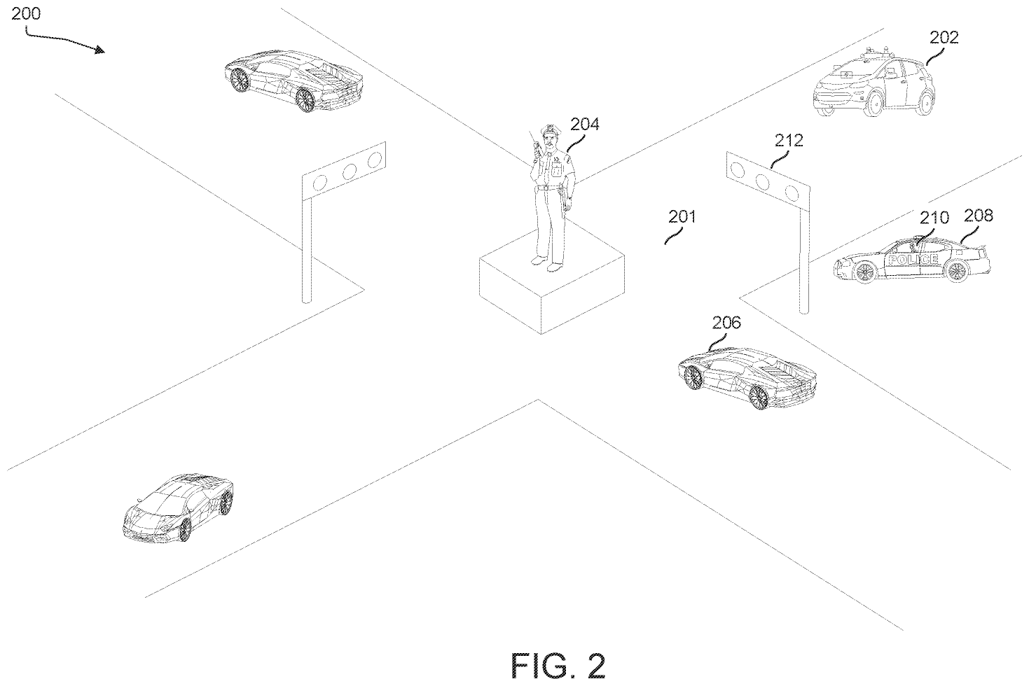

In some cases, AV 102 may include a repository of road data (e.g., sensor data such as LiDAR, RADAR ultrasonic, Inertial Measurement Unit (IMU), Global Navigation Satellite System (GNSS) as illustrated by sensor systems 504, 506 and 508 in FIG. 5) from other autonomous vehicles (not illustrated) in other special driving situations or scenarios (e.g., other construction zones or traffic scenarios). This repository of data may be used by the operating instructions stored on AV 102 or remote from AV 102 to make a determination on the presence of HCT 104, whether or not HCT 104 is active or inactive, whether or not HCT 104 is communicating with AV 102, the authority or authority level of HCT 104 (which will be discussed in further detail in FIG. 2 below), and the set of instructions that HCT 104 is communicating with AV 102. In some examples, AV 102 may leverage semantic map (e.g., pre-mapped/labeled map data) so when HCT 104 is standing in a crosswalk, AV 102 may determine that HCT 104 is in a crosswalk (e.g., AV 102 may consequently determine whether HCT 104 is actively communicating with AV 102).

FIG. 2 illustrates another example of a scenario 200 in which an autonomous vehicle-based classification of signs and gestures process may be implemented. Scenario 200 includes traffic intersection 201, AV 202, HCT 204, one or more vehicles 206, one or more traffic lights 212, law enforcement vehicle 208, and second HCT 210. As illustrated in FIG. 2, scenario 200 may represent a traffic intersection 201 in which one or more traffic lights 212 are not functioning. In other words, AV 202 and other vehicles 206 are unable to make a determination on when to proceed through traffic intersection 201 based on data (e.g., the green, yellow or red light color) communicated by traffic light 212. As a result, HCT 204 may be present to communicate with vehicles 206 and AV 202 on how to proceed through traffic intersection 201.

As discussed above in FIG. 1, HCT 104 may use gestures (e.g., hand, body, face gestures), signs, or a combination thereof to communicate with AV 202. In scenario 200, HCT 204 may use gestures to communicate with AV 202 on when to navigate through traffic intersection 201 (e.g., compared to when other vehicles 206) and the direction that AV 202 may navigate to (e.g., one of the four lanes as illustrated in FIG. 2). In some cases, HCT 204 may instruct AV 202 to navigate through a road, path or lane that would normally not be suitable to drive on. In other words, the special driving situation may involve a lane closure that requires AV 202 to navigate through a lane that is normally meant for vehicles driving in another direction. In some instances, the HCT 204 may facilitate AV 202 to override or modify the nominal set of driving behaviors of AV 202 to allow for navigation on roads, lanes or paths that would be unacceptable in a normal scenario (e.g., if there were not a special driving situation such as a lane closure, construction zone, etc.).

In some instances, AV 202 may include machine learning algorithms (e.g., via deep learning neural network 600 as illustrated in FIG. 6) to detect an authority level of HCT 204. In other words, AV 202 may be able to determine whether or not HCT 204 has the authority to instruct AV 202 and consequently impact the planning or cause a change in trajectory of AV 202. For example, an authority level of HCT 204 that AV 202 may comply with would be an HCT 204 that is a law enforcement officer, traffic officer, school crossing guard, emergency service personnel or other government personnel with legal authority to communicate navigation instructions to vehicles. Those skilled in the art will appreciate additional examples of an HCT 204 that has the authority to communicate navigation instructions to vehicles. In some cases, there may be an HCT 204 (e.g., a pedestrian in another vehicle or on the ground) communicating with AV 202 that AV 202 determines (e.g., via machine learning algorithms) does not have the authority to impact the planning or cause a change in trajectory of AV 202. As a result, if a determination is made by AV 202 that HCT 204 does not have the appropriate authority, then AV 202 may not utilize (e.g., AV 202 may not change or modify its trajectory) the data communicated by HCT 204. In some cases, AV 202 may use machine learning algorithms to determine an authority level of HCT 204 or there may be stored data (e.g., a table of data) on AV 202 that indicates authority levels of different examples of HCT 204. In another example, there may be a second HCT 210 located near vehicles associated with an authority entity including, but not limited to law enforcement vehicles 208 (also emergency vehicles) that may use gestures as discussed above to communicate instructions to AV 202. In this example, AV 202 may use machine learning algorithms to determine the authority level of second HCT 210 based on the vehicle type and make a determination on whether or not to change its respective planning and trajectory based on the determined authority level of second HCT 210. Those skilled in the art will appreciate additional vehicles besides law enforcement vehicle 208 which may include a second HCT 210. In addition to the examples as illustrated in FIG. 1 and FIG. 2, there may be an active emergency vehicle scene with a police officer directing traffic and communicating with an AV.

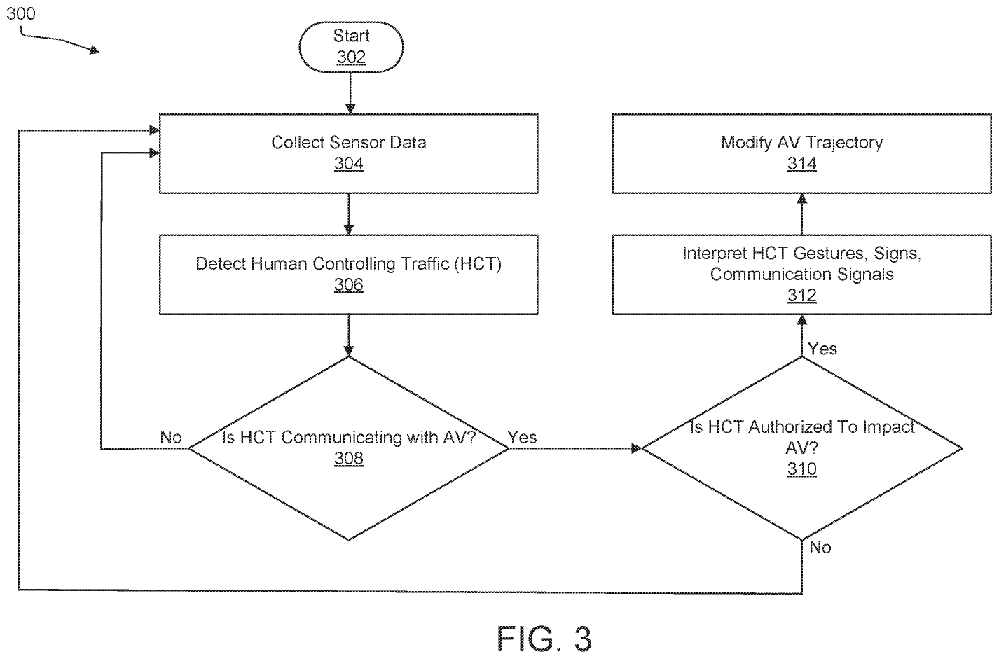

FIG. 3 illustrates an example of a process 300 for AV based classification of signs and gestures of humans controlling traffic. In some examples, the process 300 may start at operation 302 to begin classifying signs and gestures associated with humans controlling traffic. An applicable technique for classifying sings and gestures associated with humans controlling traffic in relation to the actual directive of traffic in an environment can be applied herein. For example, movements and gestures made by an HCT can be classified into traffic directives as part of classifying signs and gestures of the HCT.

Sign and gesture classification can be performed based on a context associated with a human directing traffic in an environment. Context associated with an HCT directing traffic in an environment can include applicable characteristics of the human acting or not acting to direct traffic. For example, the context can include characteristics of signs and signals made by the HCT or controlled by the HCT in the environment. In another example, the context can include an appearance or other perceivable characteristics of the HCT that can be used in classifying the HCT.

Further, context associated with an HCT directing traffic in an environment can include applicable characteristics of the environment itself. Specifically, context associated with an HCT directing traffic in an environment can include characteristics of other objects (e.g. automobiles, construction vehicles nearby, pedestrians in the case of crossing guards, static objects such as construction cones, etc.) in interacting with the HCT in the environment. For example, the context can include that other automobiles are following a specific path around a construction zone in response to specific gestures made by the HCT. Further, context associated with an HCT directing traffic in an environment can include characteristics of other humans associated with the HCT, or an assumed HCT, in an environment. For example, the context can include that another human is actually directing traffic and that automobiles are responding to the other human.

At operation 304, the computer system (e.g., local computing device 510 as illustrated in FIG. 5) of an AV may collect sensor data of the real-world environment where the AV is autonomously navigating. The sensor data can include applicable data for controlling an AV autonomously in the environment. Specifically, the sensor data can include real-world data that is gathered and generated as the AV operates autonomously in the environment.

At operation 306, the process 300 continues to detect an HCT. For example, an AV may use machine learning algorithms (e.g., via a deep learning neural network 600 as illustrated in FIG. 6) to detect the presence of an HCT in the surrounding real-world environment. In some instances, the machine learning algorithms may analyze characteristics of the potential HCT including, but not limited to, clothing, location (e.g., is the potential HCT near a law enforcement vehicle), and accessories (e.g., objects within proximity or on the clothing of the potential HCT) to determine whether or not the potential HCT is an actual HCT.

At operation 308, the process 300 includes determining (e.g., via the computer system of the AV) whether the HCT is communicating with the AV. For example, the HCT may be communicating (e.g., using gestures or a sign) with other vehicles on the road. In another example, the HCT may be located at a distance (e.g., geometric distance such as the distance in Euclidean space between the HCT and AV) such that the machine learning algorithms of the AV determine that the HCT is too distant or too far from the AV to be communicating with the AV. In other words, there may be a threshold distance or threshold geometric distance that determines whether or not the HCT is communicating with the AV (e.g., if the geometric distance between the AV and HCT is above the threshold geometric distance, then the AV determines that the HCT is not communicating with the AV). In another example, there may be one or more threshold times that indicate whether or not the HCT is interacting with the AV. For example, if the HCT is communicating (e.g., visually via eye contact, gesturing, holding a sign towards the AV) with the AV above a threshold time, then it is determined that the HCT is communicating with the AV. In some cases, the HCT may be located on a lane with vehicles traveling in another direction than the AV or facing another direction than the AV which may indicate that the HCT is not communicating with the AV. If a determination is made that the HCT is not communicating with the AV, the process 300 goes back to operation 304 where the AV continues collecting sensor data of the surrounding real-world environment. If a determination is made that the HCT is communicating with the AV, the process 300 continues to operation 310.

At operation 310, the process 300 includes determining whether the HCT is authorized to impact the AV. In some instances, operation 308 and operation 310 may also occur in reverse order. In other words, a determination is made whether or not the HCT has the authority to provide navigation instructions to the AV. In some instances, the AV may use machine learning algorithms to analyze characteristics of the HCT to determine if the HCT has the authority to impact the navigation or behavior of the AV. Examples of an HCT that has the authority to impact the navigation or behavior of the AV may include, but are not limited to, a traffic controller, emergency services worker, law enforcement officer, firefighter, and construction worker. In some cases, the AV may detect a characteristic of an HCT clothing item or accessory (e.g., a vest or badge on the HCT) and/or proximity to a government vehicle (e.g., the distance of the HCT to a law enforcement vehicle, emergency services vehicle, government vehicle, etc.). In another example, the AV may track other signs of authority of the HCT such as determining whether or not other AVs are following the communicated instructions of the HCT. Those skilled in the art will appreciate additional examples of HCTs (e.g., HCT characteristics and attributes) that are authorized to impact the navigation or behavior of the AV. If a determination is made that the HCT is not authorized to impact the AV, the process 300 returns back to operation 304 where the AV continues collecting sensor data of the surrounding real-world environment. If a determination is made that the HCT is authorized to impact the AV, the process 300 continues to operation 312.

At operation 312, the process 300 includes interpreting HCT gestures (e.g., hand gestures, facial gestures, gaze, eye contact, body gestures, etc.), a sign (e.g., stop, slowdown, turn left, turn right, take a detour, etc.), and communication signals (e.g., verbal communication). For example, the AV may use machine learning algorithms to interpret the meaning of the communication signals of the HCT and adjust its trajectory accordingly.

Communications signaled in association with an HCT can be semantically interpreted based on the previously described context associated with the HCT directing traffic in an environment. Specifically, the communications can be interpreted to identify directive rules for a zone, lane, intersection, roadway, direction of traffic, set of vehicles, set of pedestrians or otherwise a region in which the HCT is acting as authority in controlling traffic. In some cases, the communications may not just be limited to spatial representation. The directive rules can specify channels and other traffic considerations for traversal in such channels by vehicles. The directive rules may include at least one of specific alternative routes, paths, modifying the interpretation of road rules, the need to stop, proceed through a light, proceed through a stop sign, or a combination thereof. More specifically, HCT position, position of the AV, lane information, how other objects are operating in relation to the HCT in the environment, and other applicable context information can be used to formulate directive rules in interpreting the communications signals.

Finally, at operation 314 the AV may modify its trajectory based on the communication or set of instructions from the HCT. The AV can modify its trajectory as part of planning a response to an interpreted directive of the HCT. In planning a response to an interpreted directive of the HCT, the AV can plan a route through a channel according to the interpreted directive. For example, the AV can plan a route through a one-way traffic lane when the HCT signals the AV to pass through the one-way traffic lane.

In planning a response to an interpreted directive, the AV can determine whether to involve a human (e.g., a remote human), in controlling the AV. As follows, the AV can give control (e.g., remote control), of the AV to the human as part of planning the response if it determines to give control to the human. The AV can determine whether to give control to a human based on risks associated with the AV controlling itself through a zone in which an HCT is directing traffic. For example, if a channel in which an AV is being directed is a one lane channel that supports two-way traffic for a specific length, then the AV can give control to a human.

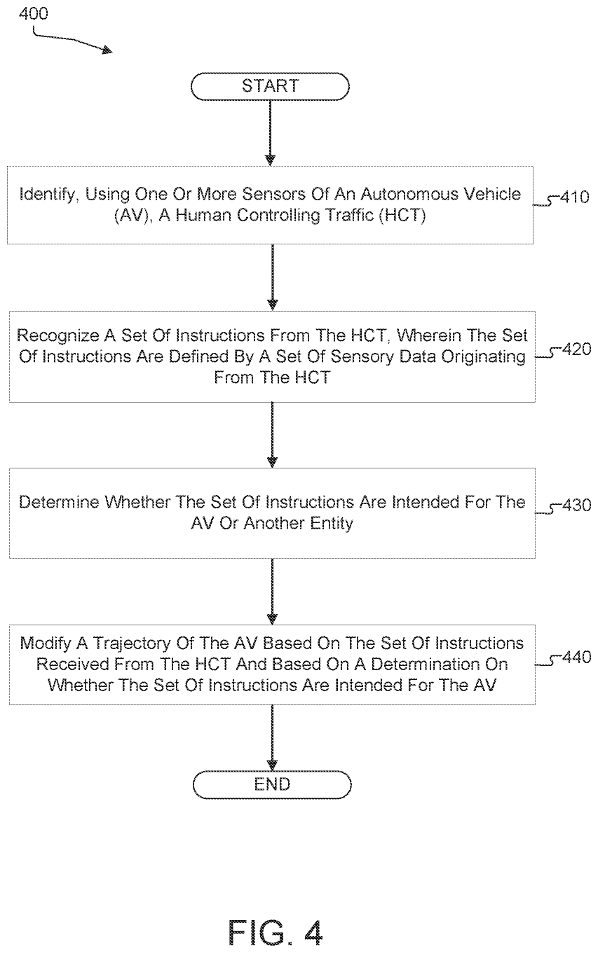

FIG. 4 illustrates another example of a process 400 for AV based classification of signs and gestures of humans controlling traffic. At block 410, process 300 includes identifying, using one or more sensors of an autonomous vehicle, a human controlling traffic. For example, AV 102 may use machine learning algorithms to identify one or more HCTs 104 in the surrounding environment.

At block 420, the process 400 includes recognizing a set of instructions from the HCT, wherein the set of instructions comprises a set of sensory data. For example, AV 102 may recognize one or more sets of instructions communicated by HCT 104 by means of sensory data such as a sign 106 or gestures 108. In some approaches, HCT 104 may use a combination of gestures 108 and a sign 106 to convey instructions (e.g., navigation instructions) to AV 102.

At block 430, the process 400 includes determining whether the set of instructions are intended for the AV or another entity. For example, AV 102 may use machine learning algorithms to determine whether or not the set of instructions (e.g., verbal communication, gestures 108, sign 106, etc.) received from HCT 104 is intended for AV 102 or another vehicle. In some instances, AV 102 may base the determination on whether or not the set of instructions received from HCT 104 is intended for AV 102 on geometric distance (e.g., Euclidean distance between AV 102 and HCT 104) and/or communication time (e.g., how long HCT 104 is gazing towards AV 102 or sending other sensory data to AV 102).

At block 440, the process 400 includes modifying a trajectory of the AV based on the set of instructions received from the HCT and based on a determination on whether the set of instructions are intended for the AV. For example, the AV 102 may modify the trajectory of the AV 102 based on the set of instructions received from HCT 104 and based on a determination (e.g., using machine learning algorithms) on whether the set of instructions are intended for the AV (e.g., rather than intended for other vehicles). In some cases, the determination on whether the set of instructions are intended for the AV 102 may be based on the distance of the HCT 104 from the AV 102 (e.g., the distance of the HCT 104 in relation to AV 102 impacts the probability that the set of instructions are intended for AV 102). For example, if the HCT 104 is at a distance above a pre-determined threshold from AV 102, then AV 102 may determine that the set of instructions are not intended for AV 102. In some instances, the determination on whether the set of instructions are intended for AV 102 may be based on the authority level of HCT 104 as discussed above or the context of the scene (e.g., HCT 104 may be located in another lane with opposing traffic compared to AV 102, gesturing to other vehicles or showing a sign to other vehicles, not gazing in the direction of AV 102, etc.).

In some examples, the authority level is determined using a deep learning neural network, or other machine learning technique, stored on the AV. For example, AV 102 may include a deep learning neural network 600 which may include machine learning algorithms capable of determining the authority level of HCT 104. In some examples, the set of sensory data comprises at least one of one or more hand gestures, one or more body gestures, one or more face gestures, one or more signs, or a combination thereof. For example, HCT 104 may transmit a set of instructions to AV 102 via sensory data such as hand gestures 108, body gestures (e.g., physical movement of the body or one or more body parts such as movement of the arms in a direction), one or more face gestures (e.g., gazing in a direction or moving the head in a direction where AV 102 should navigate), one or more signs (e.g., a hand-held sign or sign placed on the ground with instructions for AV 102 to slowdown, turn in a particular direction, stop, etc.), or a combination thereof. In some examples, the HCT is identified using a deep learning neural network. For example, AV 102 may include a deep learning neural network 600 which may include machine learning algorithms capable of determining whether or not an individual is an HCT 104 rather than a pedestrian. In some examples, the HCT is located in at least one of a construction zone, traffic intersection, a special driving situation, a vehicle, or a combination thereof. For example, HCT 104 may be located in a construction zone 110, traffic intersection 201, a special driving situation which may require an HCT 104 to instruct vehicles on the road, a vehicle such as a law enforcement vehicle 208, emergency services vehicle, or a vehicle from the fire department.

FIG. 5 is a diagram illustrating an example autonomous vehicle (AV) environment 500, according to some examples of the present disclosure. One of ordinary skill in the art will understand that, for AV environment 500 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 500 includes an AV 502, a data center 550, and a client computing device 570. The AV 502, the data center 550, and the client computing device 570 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 502 can navigate roadways without a human driver based on sensor signals generated by multiple sensor systems 504, 506, and 508. The sensor systems 504-508 can include one or more types of sensors and can be arranged about the AV 502. For instance, the sensor systems 504-508 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 504 can be a camera system, the sensor system 506 can be a LIDAR system, and the sensor system 508 can be a RADAR system. Other examples may include any other number and type of sensors.

The AV 502 can also include several mechanical systems that can be used to maneuver or operate the AV 502. For instance, the mechanical systems can include a vehicle propulsion system 530, a braking system 532, a steering system 534, a safety system 536, and a cabin system 538, among other systems. The vehicle propulsion system 530 can include an electric motor, an internal combustion engine, or both. The braking system 532 can include an engine brake, brake pads, actuators, and/or any other suitable componentry configured to assist in decelerating the AV 502. The steering system 534 can include suitable componentry configured to control the direction of movement of the AV 502 during navigation. The safety system 536 can include lights and signal indicators, a parking brake, airbags, and so forth. The cabin system 538 can include cabin temperature control systems, in-cabin entertainment systems, and so forth. In some examples, the AV 502 might not include human driver actuators (e.g., steering wheel, handbrake, foot brake pedal, foot accelerator pedal, turn signal lever, window wipers, etc.) for controlling the AV 502. Instead, the cabin system 538 can include one or more client interfaces (e.g., Graphical User Interfaces (GUIs), Voice User Interfaces (VUIs), etc.) for controlling certain aspects of the mechanical systems 530-538.

The AV 502 can include a local computing device 510 that is in communication with the sensor systems 504-508, the mechanical systems 530-538, the data center 550, and the client computing device 570, among other systems. The local computing device 510 can include one or more processors and memory, including instructions that can be executed by the one or more processors. The instructions can make up one or more software stacks or components responsible for controlling the AV 502; communicating with the data center 550, the client computing device 570, and other systems; receiving inputs from riders, passengers, and other entities within the AV's environment; logging metrics collected by the sensor systems 504-508; and so forth. In this example, the local computing device 510 includes a perception stack 512, a localization stack 514, a prediction stack 516, a planning stack 518, a communications stack 520, a control stack 522, an AV operational database 524, and an HD geospatial database 526, among other stacks and systems.

Perception stack 512 can enable the AV 502 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 504-508, the localization stack 514, the HD geospatial database 526, other components of the AV, and other data sources (e.g., the data center 550, the client computing device 570, third party data sources, etc.). The perception stack 512 can detect and classify objects and determine their current locations, speeds, directions, and the like. In addition, the perception stack 512 can determine the free space around the AV 502 (e.g., to maintain a safe distance from other objects, change lanes, park the AV, etc.). The perception stack 512 can identify environmental uncertainties, such as where to look for moving objects, flag areas that may be obscured or blocked from view, and so forth. In some examples, an output of the perception stack 512 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Localization stack 514 can determine the AV's position and orientation (pose) using different methods from multiple systems (e.g., GPS, IMUs, cameras, LIDAR, RADAR, ultrasonic sensors, the HD geospatial database 526, etc.). For example, in some cases, the AV 502 can compare sensor data captured in real-time by the sensor systems 504-508 to data in the HD geospatial database 526 to determine its precise (e.g., accurate to the order of a few centimeters or less) position and orientation. The AV 502 can focus its search based on sensor data from one or more first sensor systems (e.g., GPS) by matching sensor data from one or more second sensor systems (e.g., LIDAR). If the mapping and localization information from one system is unavailable, the AV 502 can use mapping and localization information from a redundant system and/or from remote data sources.

Prediction stack 516 can receive information from the localization stack 514 and objects identified by the perception stack 512 and predict a future path for the objects. In some examples, the prediction stack 516 can output several likely paths that an object is predicted to take along with a probability associated with each path. For each predicted path, the prediction stack 516 can also output a range of points along the path corresponding to a predicted location of the object along the path at future time intervals along with an expected error value for each of the points that indicates a probabilistic deviation from that point.

Planning stack 518 can determine how to maneuver or operate the AV 502 safely and efficiently in its environment. For example, the planning stack 518 can receive the location, speed, and direction of the AV 502, geospatial data, data regarding objects sharing the road with the AV 502 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 502 from one point to another and outputs from the perception stack 512, localization stack 514, and prediction stack 516. The planning stack 518 can determine multiple sets of one or more mechanical operations that the AV 502 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 518 can select from multiple backup plans to carry out. For example, while preparing to change lanes to turn right at an intersection, another vehicle may aggressively cut into the destination lane, making the lane change unsafe. The planning stack 518 could have already determined an alternative plan for such an event. Upon its occurrence, it could help direct the AV 502 to go around the block instead of blocking a current lane while waiting for an opening to change lanes.

Control stack 522 can manage the operation of the vehicle propulsion system 530, the braking system 532, the steering system 534, the safety system 536, and the cabin system 538. The control stack 522 can receive sensor signals from the sensor systems 504-508 as well as communicate with other stacks or components of the local computing device 510 or a remote system (e.g., the data center 550) to effectuate operation of the AV 502. For example, the control stack 522 can implement the final path or actions from the multiple paths or actions provided by the planning stack 518. This can involve turning the routes and decisions from the planning stack 518 into commands for the actuators that control the AV's steering, throttle, brake, and drive unit.

Communications stack 520 can transmit and receive signals between the various stacks and other components of the AV 502 and between the AV 502, the data center 550, the client computing device 570, and other remote systems. The communications stack 520 can enable the local computing device 510 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 520 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 526 can store HD maps and related data of the streets upon which the AV 502 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

AV operational database 524 can store raw AV data generated by the sensor systems 504-508, stacks 512-522, and other components of the AV 502 and/or data received by the AV 502 from remote systems (e.g., the data center 550, the client computing device 570, etc.). In some examples, the raw AV data can include HD LIDAR point cloud data, image data, RADAR data, GPS data, and other sensor data that the data center 550 can use for creating or updating AV geospatial data or for creating simulations of situations encountered by AV 502 for future testing or training of various machine learning algorithms that are incorporated in the local computing device 510.

Data center 550 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 550 can include one or more computing devices remote to the local computing device 510 for managing a fleet of AVs and AV-related services. For example, in addition to managing the AV 502, the data center 550 may also support a ride-hailing service (e.g., a ridesharing service), a delivery service, a remote/roadside assistance service, street services (e.g., street mapping, street patrol, street cleaning, street metering, parking reservation, etc.), and the like.

Data center 550 can send and receive various signals to and from the AV 502 and the client computing device 570. These signals can include sensor data captured by the sensor systems 504-508, roadside assistance requests, software updates, ride-hailing/ridesharing pick-up and drop-off instructions, and so forth. In this example, the data center 550 includes a data management platform 552, an Artificial Intelligence/Machine Learning (AI/ML) platform 554, a simulation platform 556, a remote assistance platform 558, and a ride-hailing platform 560, and a map management platform 562, among other systems.

Data management platform 552 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ride-hailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 550 can access data stored by the data management platform 552 to provide their respective services.

The AI/ML platform 554 can provide the infrastructure for training and evaluating machine learning algorithms for operating the AV 502, the simulation platform 556, the remote assistance platform 558, the ride-hailing platform 560, the map management platform 562, and other platforms and systems. Using the AI/ML platform 554, data scientists can prepare data sets from the data management platform 552; select, design, and train machine learning models; evaluate, refine, and deploy the models; maintain, monitor, and retrain the models; and so on.

Simulation platform 556 can enable testing and validation of the algorithms, machine learning models, neural networks, and other development efforts for the AV 502, the remote assistance platform 558, the ride-hailing platform 560, the map management platform 562, and other platforms and systems. Simulation platform 556 can replicate a variety of driving environments and/or reproduce real-world scenarios from data captured by the AV 502, including rendering geospatial information and road infrastructure (e.g., streets, lanes, crosswalks, traffic lights, stop signs, etc.) obtained from a cartography platform (e.g., map management platform 562); modeling the behavior of other vehicles, bicycles, pedestrians, and other dynamic elements; simulating inclement weather conditions, different traffic scenarios; and so on.

Remote assistance platform 558 can generate and transmit instructions regarding the operation of the AV 502. For example, in response to an output of the AI/ML platform 554 or other system of the data center 550, the remote assistance platform 558 can prepare instructions for one or more stacks or other components of the AV 502.

Ride-hailing platform 560 can interact with a customer of a ride-hailing service via a ride-hailing application 572 executing on the client computing device 570. The client computing device 570 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ride-hailing application 572. The client computing device 570 can be a customer's mobile computing device or a computing device integrated with the AV 502 (e.g., the local computing device 510). The ride-hailing platform 560 can receive requests to pick up or drop off from the ride-hailing application 572 and dispatch the AV 502 for the trip.

Map management platform 562 can provide a set of tools for the manipulation and management of geographic and spatial (geospatial) and related attribute data. The data management platform 552 can receive LIDAR point cloud data, image data (e.g., still image, video, etc.), RADAR data, GPS data, and other sensor data (e.g., raw data) from one or more AVs 502, Unmanned Aerial Vehicles (UAVs), satellites, third-party mapping services, and other sources of geospatially referenced data. The raw data can be processed, and map management platform 562 can render base representations (e.g., tiles (2D), bounding volumes (3D), etc.) of the AV geospatial data to enable users to view, query, label, edit, and otherwise interact with the data. Map management platform 562 can manage workflows and tasks for operating on the AV geospatial data. Map management platform 562 can control access to the AV geospatial data, including granting or limiting access to the AV geospatial data based on user-based, role-based, group-based, task-based, and other attribute-based access control mechanisms. Map management platform 562 can provide version control for the AV geospatial data, such as to track specific changes that (human or machine) map editors have made to the data and to revert changes when necessary. Map management platform 562 can administer release management of the AV geospatial data, including distributing suitable iterations of the data to different users, computing devices, AVs, and other consumers of HD maps. Map management platform 562 can provide analytics regarding the AV geospatial data and related data, such as to generate insights relating to the throughput and quality of mapping tasks.

In some embodiments, the map viewing services of map management platform 562 can be modularized and deployed as part of one or more of the platforms and systems of the data center 550. For example, the AI/ML platform 554 may incorporate the map viewing services for visualizing the effectiveness of various object detection or object classification models, the simulation platform 556 may incorporate the map viewing services for recreating and visualizing certain driving scenarios, the remote assistance platform 558 may incorporate the map viewing services for replaying traffic incidents to facilitate and coordinate aid, the ride-hailing platform 560 may incorporate the map viewing services into the client application 572 to enable passengers to view the AV 502 in transit en route to a pick-up or drop-off location, and so on.

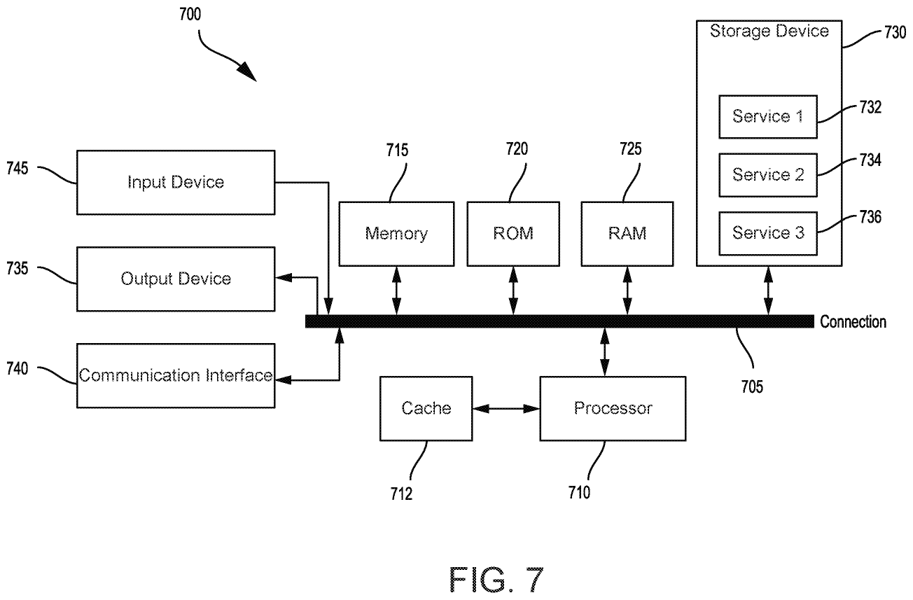

While the autonomous vehicle 502, the local computing device 510, and the autonomous vehicle environment 500 are shown to include certain systems and components, one of ordinary skill will appreciate that the autonomous vehicle 502, the local computing device 510, and/or the autonomous vehicle environment 500 can include more or fewer systems and/or components than those shown in FIG. 5. For example, the autonomous vehicle 502 can include other services than those shown in FIG. 5 and the local computing device 510 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 5. An illustrative example of a computing device and hardware components that can be implemented with the local computing device 510 is described below with respect to FIG. 7.

In FIG. 6, the disclosure now turns to a further discussion of models that can be used through the environments and techniques described herein. FIG. 6 is an example of a deep learning neural network 600 that can be used to implement all or a portion of the systems and techniques described herein (e.g., neural network 600 can be used to implement a perception module (or perception system) as discussed above). In another example, neural network 600 located on an autonomous vehicle (e.g., AV 102) may contain machine learning algorithms capable of detecting an HCT (e.g., HCT 104), the authority level of an HCT, whether or not an HCT is communicating with an AV, and interpreting the set of instructions the HCT is communicating with an AV.

In some examples, an input layer 620 can be configured to receive sensor data and/or data relating to an environment surrounding an AV. Neural network 600 includes multiple hidden layers 622a, 622b, through 622n. The hidden layers 622a, 622b, through 622n include “n” number of hidden layers, where “n” is an integer greater than or equal to one. The number of hidden layers can be made to include as many layers as needed for the given application. Neural network 600 further includes an output layer 621 that provides an output resulting from the processing performed by the hidden layers 622a, 622b, through 622n.

Neural network 600 is a multi-layer neural network of interconnected nodes. Each node can represent a piece of information. Information associated with the nodes is shared among the different layers and each layer retains information as information is processed. In some cases, the neural network 600 can include a feed-forward network, in which case there are no feedback connections where outputs of the network are fed back into itself. In some cases, the neural network 600 can include a recurrent neural network, which can have loops that allow information to be carried across nodes while reading in input.

Information can be exchanged between nodes through node-to-node interconnections between the various layers. Nodes of the input layer 620 can activate a set of nodes in the first hidden layer 622a. For example, as shown, each of the input nodes of the input layer 620 is connected to each of the nodes of the first hidden layer 622a. The nodes of the first hidden layer 622a can transform the information of each input node by applying activation functions to the input node information. The information derived from the transformation can then be passed to and can activate the nodes of the next hidden layer 622b, which can perform their own designated functions. Example functions include convolutional, up-sampling, data transformation, and/or any other suitable functions. The output of the hidden layer 622b can then activate nodes of the next hidden layer, and so on. The output of the last hidden layer 622n can activate one or more nodes of the output layer 621, at which an output is provided. In some cases, while nodes in the neural network 600 are shown as having multiple output lines, a node can have a single output and all lines shown as being output from a node represent the same output value.

In some cases, each node or interconnection between nodes can have a weight that is a set of parameters derived from the training of the neural network 600. Once the neural network 600 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 600 to be adaptive to inputs and able to learn as more and more data is processed.

The neural network 600 is pre-trained to process the features from the data in the input layer 620 using the different hidden layers 622a, 622b, through 622n in order to provide the output through the output layer 621.

In some cases, the neural network 600 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 600 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½ (target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 600 can perform a backward pass by determining which inputs (weights) most contributed to the loss of the network, and can adjust the weights so that the loss decreases and is eventually minimized.

The neural network 600 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 600 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 7 illustrates an example processor-based system with which some aspects of the subject technology can be implemented. For example, processor-based system 700 can be any computing device making up, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (Central Processing Unit (CPU) or processor) 710 and connection 705 that couples various system components including system memory 715, such as Read-Only Memory (ROM) 720 and Random-Access Memory (RAM) 725 to processor 710. Computing system 700 can include a cache of high-speed memory 712 connected directly with, in close proximity to, or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 730 can include software services, servers, services, etc., that when the code that defines such software is executed by the processor 710, it causes the system 700 to perform a function. In some embodiments, a hardware service that performs a particular function can include the software component stored in a computer-readable medium in connection with the necessary hardware components, such as processor 710, connection 705, output device 735, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing operations of the methods disclosed herein. The particular sequence of such executable instructions or associated data structures represents examples of corresponding acts for implementing the functions described in such operations.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

### Illustrative Examples of the Disclosure Include:

Aspect 1. A system comprising: at least one memory; and at least one processor coupled to the at least one memory, the at least one processor configured to: identify, using one or more sensors of an autonomous vehicle (AV), a human controlling traffic (HCT); recognize a set of instructions from the HCT, wherein the set of instructions are defined by a set of sensory data originating from the HCT; determine whether the set of instructions are intended for the AV or another entity; and modify a trajectory of the AV based on the set of instructions received from the HCT and based on a determination on whether the set of instructions are intended for the AV.

Aspect 2. The system of Aspect 1, wherein the determination on whether the set of instructions are intended for the AV is based on an authority level associated with the HCT.

Aspect 3. The system of Aspect 2, wherein the authority level is determined using a deep learning neural network stored on the AV.

Aspect 4. The system of any of Aspects 1-3, wherein the determination on whether the set of instructions are intended for the AV is based on either or both a geometric relationship between the HCT and the AV and semantic map data.

Aspect 5. The system of any of Aspects 1-4, wherein the set of sensory data comprises at least one of one or more hand gestures, one or more body gestures, one or more face gestures, attire of the HTC, one or more signs, or a combination thereof.

Aspect 6. The system of any of Aspects 1-5, wherein the HCT is identified using a deep learning neural network located on the AV.

Aspect 7. The system of any of Aspects 1-6, wherein the HCT is located in at least one of a construction zone, traffic intersection, a special driving situation, a vehicle, or a combination thereof.

Aspect 8. A computer implemented method comprising: identifying, using one or more sensors of an autonomous vehicle (AV), a human controlling traffic (HCT); recognizing a set of instructions from the HCT, wherein the set of instructions are defined by a set of sensory data originating from the HCT; determining whether the set of instructions are intended for the AV or another entity; and modifying a trajectory of the AV based on the set of instructions received from the HCT and based on a determination on whether the set of instructions are intended for the AV.

Aspect 9. The computer implemented method of Aspect 8, wherein the determination on whether the set of instructions are intended for the AV is based on an authority level associated with the HCT.

Aspect 10. The computer implemented method of Aspect 9, wherein the authority level is determined using a deep learning neural network stored on the AV.

Aspect 11. The computer implemented method of any of Aspects 8-10, wherein the determination on whether the set of instructions are intended for the AV is based on either or both a geometric relationship between the HCT and the AV and semantic map data.

Aspect 12. The computer implemented method of any of Aspects 8-11, wherein the set of sensory data comprises at least one of one or more hand gestures, one or more body gestures, one or more face gestures, attire of the HTC, one or more signs, or a combination thereof.

Aspect 13. The computer implemented method of any of Aspects 8-12, wherein the HCT is identified using a deep learning neural network located on the AV.

Aspect 14. The computer implemented method of any of Aspects 8-13, wherein the HCT is located in at least one of a construction zone, traffic intersection, a special driving situation, a vehicle, or a combination thereof.

Aspect 15. A non-transitory computer-readable storage medium comprising at least one instruction for causing a computer or processor to: identify, using one or more sensors of an autonomous vehicle (AV), a human controlling traffic (HCT); recognize a set of instructions from the HCT, wherein the set of instructions are defined by a set of sensory data originating from the HCT; determine whether the set of instructions are intended for the AV or another entity; and modify a trajectory of the AV based on the set of instructions received from the HCT and based on a determination on whether the set of instructions are intended for the AV.

Aspect 16. The non-transitory computer-readable storage medium of Aspect 15, wherein the determination on whether the set of instructions are intended for the AV is based on an authority level associated with the HCT.

Aspect 17. The non-transitory computer-readable storage medium of Aspect 16, wherein the authority level is determined using a deep learning neural network stored on the AV.

Aspect 18. The non-transitory computer-readable storage medium of any of Aspects 15-17, wherein the determination on whether the set of instructions are intended for the AV is based on either or both a geometric relationship between the HCT and the AV and semantic map data.

Aspect 19. The non-transitory computer-readable storage medium of any of Aspects 15-18, wherein the set of sensory data comprises at least one of one or more hand gestures, one or more body gestures, one or more face gestures, attire of the HTC, one or more signs, or a combination thereof.

Aspect 20. The non-transitory computer-readable storage medium of any of Aspects 15-19, wherein the HCT is identified using a deep learning neural network located on the AV.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A system comprising:
at least one memory; and
at least one processor coupled to the at least one memory, the at least one processor configured to:
identify, using one or more sensors of an autonomous vehicle (AV), a human controlling traffic (HCT);
recognize a set of instructions from the HCT, wherein the set of instructions are defined by a set of sensory data originating from the HCT;
determine whether the set of instructions are intended for the AV or another entity; and
modify a trajectory of the AV based on the set of instructions received from the HCT and based on a determination on whether the set of instructions are intended for the AV.

2. The system of claim 1, wherein the determination on whether the set of instructions are intended for the AV is based on an authority level associated with the HCT.

3. The system of claim 2, wherein the authority level is determined using a deep learning neural network stored on the AV.

4. The system of claim 1, wherein the determination on whether the set of instructions are intended for the AV is based on either or both a geometric relationship between the HCT and the AV and semantic map data.

5. The system of claim 1, wherein the set of sensory data comprises at least one of one or more hand gestures, one or more body gestures, one or more face gestures, attire of the HCT, one or more signs, or a combination thereof.

6. The system of claim 1, wherein the HCT is identified using a deep learning neural network located on the AV.

7. The system of claim 1, wherein the HCT is located in at least one of a construction zone, traffic intersection, a special driving situation, a vehicle, or a combination thereof.

8. A computer implemented method comprising:
identifying, using one or more sensors of an autonomous vehicle (AV), a human controlling traffic (HCT);
recognizing a set of instructions from the HCT, wherein the set of instructions are defined by a set of sensory data originating from the HCT;
determining whether the set of instructions are intended for the AV or another entity; and
modifying a trajectory of the AV based on the set of instructions received from the HCT and based on a determination on whether the set of instructions are intended for the AV.

9. The computer implemented method of claim 8, wherein the determination on whether the set of instructions are intended for the AV is based on an authority level associated with the HCT.

10. The computer implemented method of claim 9, wherein the authority level is determined using a deep learning neural network stored on the AV.

11. The computer implemented method of claim 8, wherein the determination on whether the set of instructions are intended for the AV is based on either or both a geometric relationship between the HCT and the AV and semantic map data.

12. The computer implemented method of claim 8, wherein the set of sensory data comprises at least one of one or more hand gestures, one or more body gestures, one or more face gestures, attire of the HTC, one or more signs, or a combination thereof.

13. The computer implemented method of claim 8, wherein the HCT is identified using a deep learning neural network located on the AV.

14. The computer implemented method of claim 8, wherein the HCT is located in at least one of a construction zone, traffic intersection, a special driving situation, a vehicle, or a combination thereof.

15. A non-transitory computer-readable storage medium comprising at least one instruction for causing a computer or processor to:
identify, using one or more sensors of an autonomous vehicle (AV), a human controlling traffic (HCT);
recognize a set of instructions from the HCT, wherein the set of instructions are defined by a set of sensory data originating from the HCT;
determine whether the set of instructions are intended for the AV or another entity; and
modify a trajectory of the AV based on the set of instructions received from the HCT and based on a determination on whether the set of instructions are intended for the AV.

16. The non-transitory computer-readable storage medium of claim 15, wherein the determination on whether the set of instructions are intended for the AV is based on an authority level associated with the HCT.

17. The non-transitory computer-readable storage medium of claim 16, wherein the authority level is determined using a deep learning neural network stored on the AV.

18. The non-transitory computer-readable storage medium of claim 15, wherein the determination on whether the set of instructions are intended for the AV is based on either or both a geometric relationship between the HCT and the AV and semantic map data.

19. The non-transitory computer-readable storage medium of claim 15, wherein the set of sensory data comprises at least one of one or more hand gestures, one or more body gestures, one or more face gestures, attire of the HTC, one or more signs, or a combination thereof.

20. The non-transitory computer-readable storage medium of claim 15, wherein the HCT is identified using a deep learning neural network located on the AV.
